(19) United States
(12) Patent Application Publication
(10) Pub. No.: US 2006/0036837 A1
(43) Pub. Date: Feb. 16, 2006

(54) Prophet/critic hybrid predictor

(76) Inventors: Jared W. Stark, Portland, OR (US); Ayose J. Falcon-Samper, Barcelona (ES)

Correspondence Address: TROP PRUNER & HU, PC, 8554 KATY FREEWAY, SUITE 100, HOUSTON, TX, 77024, US

(21) Appl. No.: 10/918,783

(22) Filed: Aug. 13, 2004

(51) Int. Cl. G06F 9/00

(52) U.S. Cl. 712/239

(57) ABSTRACT

A hybrid prophet/critic predictor includes a first branch predictor to provide a first branch prediction for a branch under prediction (BUP) based on a branch history of the BUP and/or a program counter, and also includes a second branch predictor to provide a second branch prediction for the BUP based on a branch future of the BUP.

### BACKGROUND

Embodiments of the present invention relate generally to prediction techniques, and may be applied more specifically to branch prediction for processors.

Processor design is typically an exercise in trading off performance, power consumption, and efficiency. Techniques that do not require making this tradeoff, that is, that provide an advantage for all three metrics, are highly desirable because they can give a design an advantage over competing designs. Better branch prediction is such a technique. It increases performance by reducing the time spent speculating on a mispredicted path, reduces power consumption by allowing the processor to run at a lower frequency (and hence voltage) and still meet its performance target, and increases efficiency by reducing the work wasted on misspeculation.

Thus a need exists for improved prediction techniques that may be applied to processor branch prediction and other areas.

### BRIEF DESCRIPTION OF THE DRAWINGS

Various embodiments of the present invention are illustrated by way of example and not limitation in the figures of the accompanying drawings, in which like references indicate similar elements.

FIG. 1 is a block diagram of a prophet/critic hybrid predictor in accordance with one embodiment of the present invention.

FIG. 2 is a block diagram of a prophet/critic hybrid predictor in accordance with another embodiment of the present invention.

FIG. 3 is a block diagram of a branch prediction architecture using a prophet/critic hybrid branch predictor in accordance with one embodiment of the present invention.

FIG. 4 is a block diagram of a filtered critic in accordance with one embodiment of the present invention.

FIG. 5 is a flow diagram illustrating a branch prediction method according to an embodiment of the present invention.

FIG. 6 is a block diagram of a computer system with which embodiments of the invention may be used.

### DETAILED DESCRIPTION

A method, apparatus, system, and article for a prophet/critic hybrid predictor are described. In the following description, for purposes of explanation, numerous specific details are set forth in order to provide a thorough understanding of embodiments of the invention. It will be apparent, however, to one skilled in the art that embodiments of the invention can be practiced without these specific details. In other instances, structures and devices are shown in block diagram form in order to avoid obscuring embodiments of the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the execution of software instructions, processors encounter numerous branches. For example, software instructions may include a conditional branch to a subroutine if a variable has a certain value; otherwise, execution continues sequentially along the current instruction path. To increase performance, modem processors speculatively pre-fetch and execute software instructions to avoid wasting the processor's time waiting for instructions to execute and to keep the processor busy. Pre-fetching instructions along the correct path is critical to keeping the processor busy doing useful work. Branch instructions (e.g., conditional branch instructions) pose the challenge of predicting which branch will be taken when the processor executes the software such that instructions associated with the correct branch (i.e., instructions in the correct instruction path) can be pre-fetched for later execution by the processor. If instructions in the incorrect branch path (i.e., instructions following a branch that was mispredicted) are pre-fetched, then time may be wasted in speculatively executing instructions along an incorrect instruction path. In this case, the incorrect instructions may need to be flushed and the process may need to be repaired back to the correct branch path. Thus, accurate branch prediction is important to processor performance.

Some embodiments of the present invention will initially be described by drawing an analogy between a processor executing a software program and taking a ride in a taxi. The taxi is the processor, the driver is the branch predictor, and the passenger is the processor's pipeline. The system of roads represents the paths through the software program. The intersections are branches; that is, points where the driver must decide a particular path to follow. It is the driver's (branch predictor's) job to navigate the taxi through the system of roads, making the correct turns at intersections (branches), to get to the destination (correct point in the software program). Wrong turns waste the passenger's time (incorrect branch predictions waste the processor pipeline's time).

Conventional branch predictors are analogous to a taxi with just one driver. The taxi driver (branch predictor) gets the passenger to the destination using knowledge of the roads acquired from previous trips; i.e., using branch history information stored in the branch predictor's memory structures. When the taxi driver (branch predictor) reaches an intersection (branch), he uses the historical knowledge to decide which way to turn. The driver accesses this knowledge in the context of his current location. Conventional branch predictors access branch history information in the context of the current location (e.g., the program counter) plus a history of the most recent branch decisions that led to the current location.

The prophet/critic hybrid predictors of various embodiments of the present invention are analogous to a taxi with two drivers: a front-seat driver and a back-seat driver. The front-seat driver has the same role as the driver in the single-driver taxi. This role is called the prophet (or prophet predictor). The back-seat driver has the role of a critic (or critic predictor). The critic watches the turns (branch predictions) the prophet makes at intersections (branches) but may not say anything unless the prophet made a bad turn (incorrect branch prediction). When the critic thinks the prophet made a bad turn, the critic may wait until the prophet makes a few more turns (additional branch predictions) to be confident they are lost before saying anything.

Conventional branch predictors may make predictions using branch history information. Once a branch has been predicted, the predictor cannot use the information from subsequent predictions to re-predict the branch. In contrast, embodiments of the prophet/critic hybrid predictor of the present invention may use information from subsequent predictions to improve prediction accuracy.

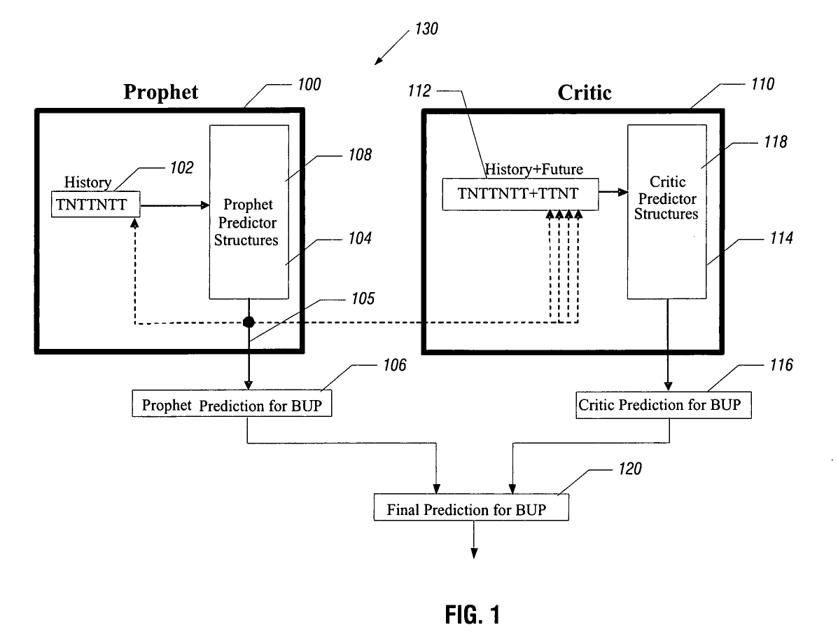

Referring now to FIG. 1, shown is a block diagram of a prophet/critic hybrid predictor 130 in accordance with one embodiment of the present invention. The prophet/critic hybrid predictor 130 may include a prophet predictor 100 that may predict branches based on the branch history 102 of the branch under prediction (BUP) by the prophet/critic hybrid predictor 130 and the prophet predictor structures 108. The branch history 102 for the branch under prediction (BUP) may include the prophet's predictions 105 for one or more branches prior to the BUP. The prophet's prediction for the BUP 106 may be used as an input to a critic predictor 110. In addition, the critic 110 may wait for the prophet 100 to provide predictions for one or more branches subsequent to the BUP. The prophet's 100 predictions for the BUP and one or more branches that follow may be referred to as the “BUP's branch future” or the “BUP's predicted branch future.” After gathering sufficient branch future information for the BUP, the critic 110 may provide a critic prediction for the BUP 116 based on the branch history and branch future of the BUP 112. The critic's prediction for the BUP 116 may also be referred to as a “critique” of the prophet's prediction for the BUP 106.

The prophet predictor 100 may use branch history 102 to predict the direction of a current branch (e.g., taken or not taken). The BUP's branch history 102 for the example shown in FIG. 1 is “TNTTNTT” meaning, starting with the most recently predicted branch at the right most position and working backward to the left, the seven prior branches were predicted to be “taken,” “taken,” “not taken,” “taken,” “taken,” “not taken,” and “taken.” The prophet's prediction 105 for a branch may then be added to the branch history 102 for use in the prophet's prediction 105 of subsequent branches. The prophet's prediction 105 for a branch may also be added to the branch history+future information 112 for use by the critic predictor 110, as will be further discussed.

Still referring to FIG. 1, the BUP's branch history and BUP's branch future are maintained as the BUP's history+future information 112 for use by the critic predictor 110. For the example shown in FIG. 1, the BUP's history+future information 112 includes the BUP's branch history “TNTTNTT” (discussed above) and the BUP's branch future “TTNT” meaning that the prophet 100 has predicted the BUP to be “taken” and the three subsequent branches to be “taken,” “not taken,” and “taken.”

Sometime after the prophet predictor 100 has moved on to predict branches that follow the BUP, the critic predictor 110 may make its own critic prediction for the BUP 116 based on the BUP history+future 112. The critic prediction for the BUP 116 may also be referred to as a “critique” of the prophet's prediction for the BUP 106. The critique 116, whether it agrees or disagrees with the prophet's prediction 106, may be used to generate a final branch prediction for the BUP 120. In one embodiment, the critic prediction for the BUP 116 may be the final prediction for the BUP 120. In another embodiment, the critic prediction for the BUP 116 may be combined with the prophet prediction for the BUP 106 to generate the final prediction for the BUP 120. In one embodiment, the critic prediction for the BUP 116 may be a single bit indicating agreement or disagreement with the prophet and the bit may be exclusive ORed (XORed) with the prophet prediction for the BUP 106 to generate the final prediction for the BUP 120.

Still referring to FIG. 1, the prophet 100 and critic 110 may use prophet predictor structures 108 and critic predictor structures 118, respectively, in generating their branch predictions. The prophet predictor structures 108 may include pattern tables that allow the prophet 100 to predict the direction of a branch based on the branch history 102. The critic predictor structures 118 may include pattern tables that allow the critic 110 to predict the direction of a branch based on the branch history and branch future information 112. As additional branch predictions are made and as branches are executed, the prophet 100 and critic 110 may train or update (speculatively or non-speculatively) the prophet 108 and critic 118 predictor structures with additional information gained.

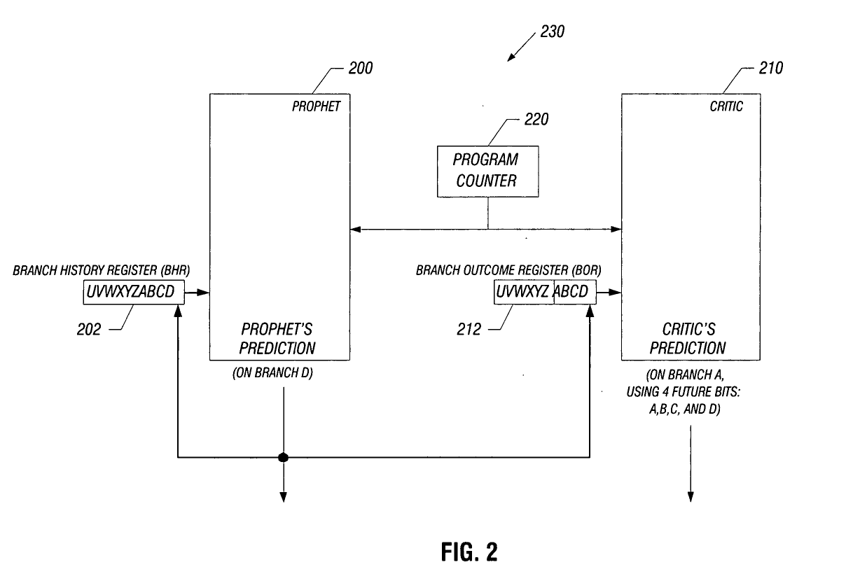

Referring now to FIG. 2, shown is a block diagram of a prophet/critic hybrid predictor 230 in accordance with another embodiment of the present invention. FIG. 2 illustrates an example where a prophet 200 has predicted various branches and stored the branch prediction information “UVWXYZABCD” in a branch history register (BHR) 202 and a branch outcome register (BOR) 212. The branch prediction information “UVWXYZABCD” in the branch history register 202 means that the prophet predictor 200 has already predicted the path of branches to be U, then V, then W, then X, then Y, then Z, then A, then B, then C, and then D. The prophet's 200 most recent prediction is for branch D, which then becomes the latest entry added to the branch history register 202 and the branch outcome register 212.

For the example shown in FIG. 2, the prophet/critic hybrid predictor's 230 branch under prediction (BUP) is branch A (even though the prophet 200 has advanced beyond A and predicted branches B, C, and D—three branches beyond A). The critic 210 may be configured to base its branch prediction for branch A on A's branch history (“UVWXYZ”) and one or more future branches in A's branch future (“ABCD”). Recall that the branch future includes the prophet's 200 prediction for the BUP (in this case “A”) and one or more subsequent branch predictions (in this case “BCD”) by the prophet 200. Thus, the critic's 210 prediction or critique for branch A is based on two kinds of branch predictions: (a) the prophet's 200 predictions of branches before the one being predicted by the critic 210, which are branch history for the critic's 210 BUP, and allow the critic 210 to correlate on the past, and (b) the prophet's 200 predictions of the branch being predicted by the critic 210 and one or more branches after it, which are branch future for the critic's 210 BUP, and allow the critic 210 to correlate on the future. Using a combination of past and future branch information, the critic 210 may provide a critic branch prediction (or critique) for a BUP that is more accurate than the prophet's earlier branch prediction (which was based on branch history).

In one embodiment, the branch history register 202 and branch outcome registers 212 may store one bit per branch and may use a 0 bit to represent a branch that is “not taken” and a 1 bit to represent branch that is “taken.”

In one embodiment, the prophet predictor 200 may be based on any one of a variety of branch predictors that predict branches based on branch history information 202 and/or a program counter 220. In one embodiment, the critic predictor 210 may predict branches based on branch future information. In another embodiment, the critic predictor 210 may predict branches based on branch future information and branch history information. In another embodiment, the critic predictor 210 may predict branches based on branch future information and the program counter 220. In another embodiment, the critic predictor 210 may predict branches based on branch future information, branch history, and the program counter 220.

Still referring to FIG. 2, the critic's 210 prediction accuracy may be limited by multiple branches contending for the same prediction resources; that is, by conflicts. Conflicts can be reduced by filtering unnecessary or easy-to-predict branches from the critic predictor 210. In one embodiment, the prophet 200 may provide a prediction for every branch, so the processor could always have an available prediction regardless of whether the critic 210 provides a critique. In one embodiment, the critic 210 may only provide a prediction in cases where the prophet 200 is likely to be wrong. Prophets 200 can correctly predict a high percentage of all branches. In one embodiment, the critic 210 may be configured to only predict the smaller percentage of branches that the prophets 200 mispredict.

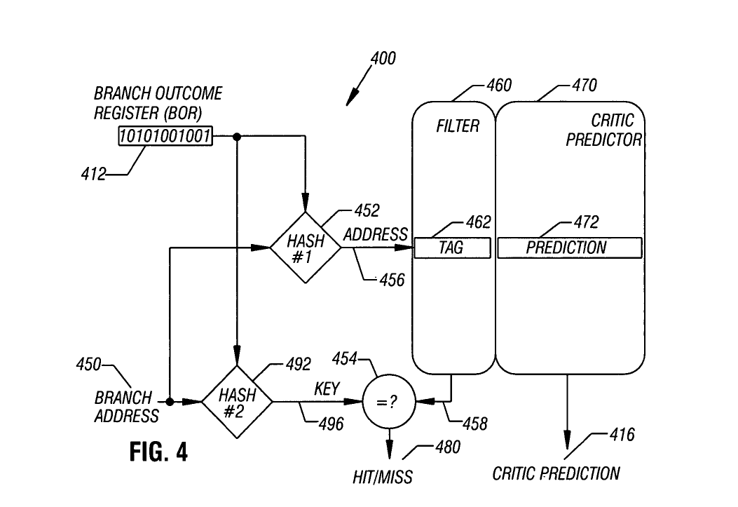

Referring now to FIG. 4, shown is a block diagram of a filtered critic 400 in accordance with one embodiment of the present invention. In one embodiment, the filtered critic 400 may include a filter or tag table 460, which may include a table of tags 462 used to filter branches. When a critic prediction for a branch is needed, the filter 460 may be accessed in two steps to determine if there is a hit in the filter 460 for that branch. First, the branch address 450 and the branch outcome register 412 values may be combined according to a first hash function 452 (or other suitable algorithm) to generate an address 456 into the filter 460. Then, the identified tag 462 may be read out of the filter 460 on signal 458. Second, the branch address 450 and the branch outcome register 412 values may be combined according to a second hash function 492 (or other suitable algorithm) to generate a key 496. Then, the identified tag 462 and the key 496 may be compared 454 to determine if the identified tag 462 “hits” or matches the branch under prediction. If there is a hit, a prediction 472 from a critic predictor 470 may be used as the critic's prediction 416. In one embodiment, if there is a hit, the critic's prediction 416 may be used as the final prediction for the BUP (and the prophet prediction may be ignored). In another embodiment, if there is a hit, the critic's prediction 416 may be combined with the prophet prediction for the BUP to generate the final prediction for the BUP. In another embodiment, if there is a hit, the critic's prediction 416 may be a single bit indicating agreement or disagreement with the prophet and the bit may be exclusive ORed (XORed) with the prophet prediction for the BUP to generate the final prediction for the BUP. In one embodiment, if there is a miss (indicating the critic predictor 470 does not have a prediction for the BUP) the critic's prediction 416 may be ignored and a prophet prediction may be used for the BUP.

In one embodiment, new entries may be added into the tag table 460 when a branch under prediction misses the filter 460 and the branch is also mispredicted by the prophet predictor. When an entry needs to be added to the tag table 460, a tag 462 may be added in two steps. First, the branch address 450 and the branch outcome register 412 values may be combined according to the first hash function 452 (or other suitable algorithm) to generate an address for the new tag 462. Second, the branch address 450 and the branch outcome register 412 may be hashed according to the second hash function 492 (or other suitable algorithm) to generate the key 496 to be stored as the new tag 462. In this manner, a new tag 462 may be generated for a mispredicted branch so that the next time that branch is encountered, the filtered critic's 400 prediction 416 will be used for the branch. In one embodiment, replacement of existing tags 462 in the filter or tag table 460 are managed according to a least-recently-used (LRU) replacement algorithm.

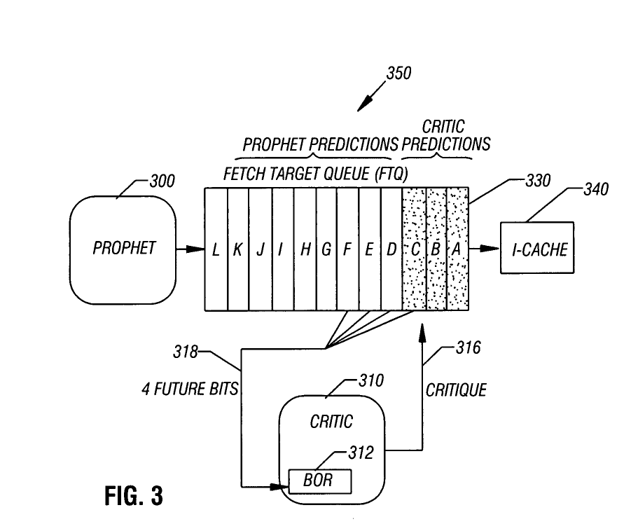

Referring now to FIG. 3, shown is a block diagram of a branch prediction architecture 350 using a prophet/critic hybrid branch predictor (300, 310) in accordance with one embodiment of the present invention. The branch prediction architecture 350 of FIG. 3 may use a fetch target queue (FTQ) 330 to decouple the prophet/critic hybrid predictor (300, 310) from the instruction cache 340 to separate branch prediction generation from branch prediction consumption. The prophet/critic hybrid predictor (300, 310) generates branch predictions and inserts them into the fetch target queue 330 for later consumption by the instruction cache 340. The prophet/critic hybrid predictor (300, 310) may be designed to produce predictions faster than the instruction cache 340 consumes them so that the fetch target queue 330 is usually full.

The prophet/critic hybrid branch predictor (300, 310) may use a branch target buffer to identify conditional branches. When a conditional branch is identified by the branch target buffer, the prophet 300 may make an initial prediction and insert it into the fetch target queue 330. This prediction may be immediately consumed by the instruction cache 340, but since insertions occur at the end of the fetch target queue 330 and the fetch target queue 330 is usually full, the prophet's 300 prediction usually spends many cycles in the fetch target queue before it is consumed by the instruction cache 340. When the prophet's 300 prediction is inserted in the fetch target queue 330, it may also be inserted in the critic's 310 branch outcome register 312 as a future bit for branches previously predicted by the prophet 300. As subsequent predictions are inserted in the fetch target queue 330 by the prophet 300, the critic 310 may gather them as future bits for its branch under prediction (BUP). In one embodiment, when the critic 310 has gathered a predetermined number of future bits (or branch future information) for its branch under prediction, it provides a critique 316 of the prophet's 300 prediction for the BUP.

Still referring to FIG. 3, if the critic 310 agrees with the prophet's 300 prediction, the prediction may be marked as having been critiqued and the critic 310 may advance to the next uncritiqued prediction in the fetch target queue 330. In FIG. 3, the shaded FTQ 330 entries hold predictions that have been critiqued, and unshaded entries hold predictions that have not been critiqued. On the other hand, if the critic 310 disagrees with the prophet's 300 prediction (e.g., the prophet's prediction is wrong), several actions may be taken: (a) the critic's prediction 316 may override the prophet's 300 prediction, (b) the overridden prediction may be marked as having been critiqued and the critic 310 may advance past the overridden prediction, (c) FTQ 330 entries holding uncritiqued predictions may be flushed, (d) the prediction structures of the prophet 300 and critic 310 may be repaired to reflect the flushing of the uncritiqued predictions, and (e) the prophet 300 may be redirected to the path predicted by the critic 310. The flush may be confined to the FTQ 330 since the instruction cache 340 and the rest of the machine have not received any of the flushed predictions. The critiqued predictions in the FTQ 330 may be left alone, so if the FTQ 330 is sufficiently full, the flush may cause no performance penalty.

The critique 316 is usually provided well before the prediction is consumed by the instruction cache 340. However, there may be cases where the instruction cache 340 requires a prediction but the critic 310 has not gathered the predetermined number of future bits. To address this situation, the critic 310 may provide a critique 316 of the prophet's 300 prediction using the available future bits, or the prophet's 300 prediction can be passed to the instruction cache 340 without having been critiqued by the critic 310.

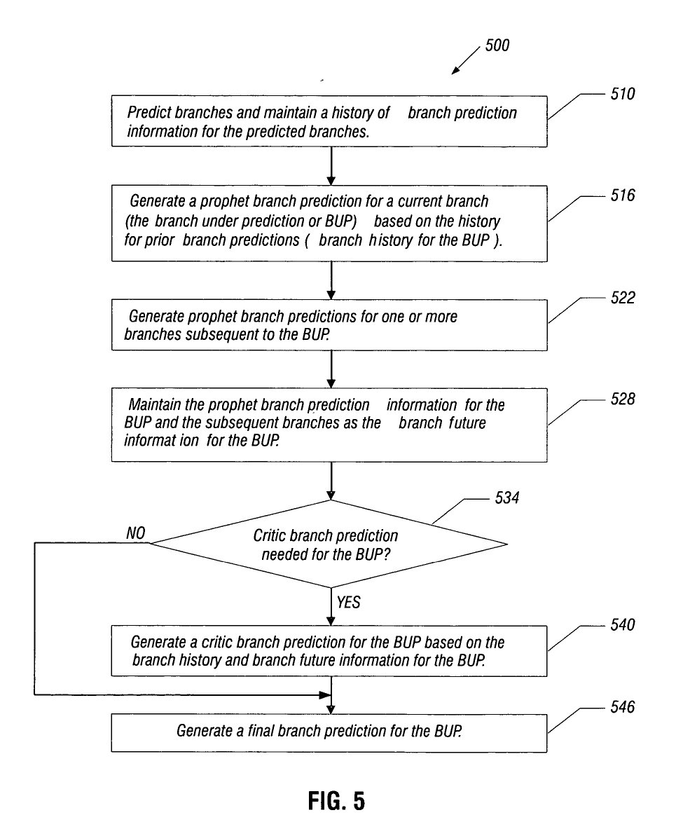

Referring now to FIG. 5, shown is a flow diagram illustrating a branch prediction method 500 according to an embodiment of the present invention. As conditional branches are encountered, predictions may be made and branch history information may be maintained (block 510). Regarding a branch under prediction (BUP), a prophet branch prediction may be made based on the BUP's branch history (block 516). Prophet branch predictions may also be made for one or more branches after the BUP (block 522). The prophet branch predictions for the BUP and the one or more subsequent branches may be maintained as the BUP's branch future (block 528). If needed, a critic branch prediction for the BUP may be made based on the BUP's branch history and branch future information (diamond 534 and block 540), and then may be combined with the prophet prediction to generate the final prediction (block 546). If a critic branch prediction for the BUP is not needed, then the critic prediction of block 540 may be skipped and a final branch prediction may be generated based on the prophet's prediction for the BUP (diamond 534 and block 546). In one embodiment, if a critic prediction is not needed for a BUP, the prophet's branch prediction may be the final branch prediction for the BUP. In another embodiment, if a critic prediction is needed for a BUP, the critic's branch prediction may be the final branch prediction for the BUP. In yet another embodiment, the prophet prediction and critic prediction may be combined to form the final branch prediction for the BUP.

Embodiments may be implemented in logic circuits, state machines, microcode, or some combination thereof. Embodiments may be implemented in code and may be stored on a storage medium having stored thereon instructions that can be used to program a computer system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), dynamic random access memories (DRAMs), erasable programmable read-only memories (EPROMs), flash memories, electrically erasable programmable read-only memories (EEPROMs), magnetic or optical cards, network storage devices, or any type of media suitable for storing electronic instructions.

Embodiments may be implemented in software for execution by a suitable computer system configured with a suitable combination of hardware devices.

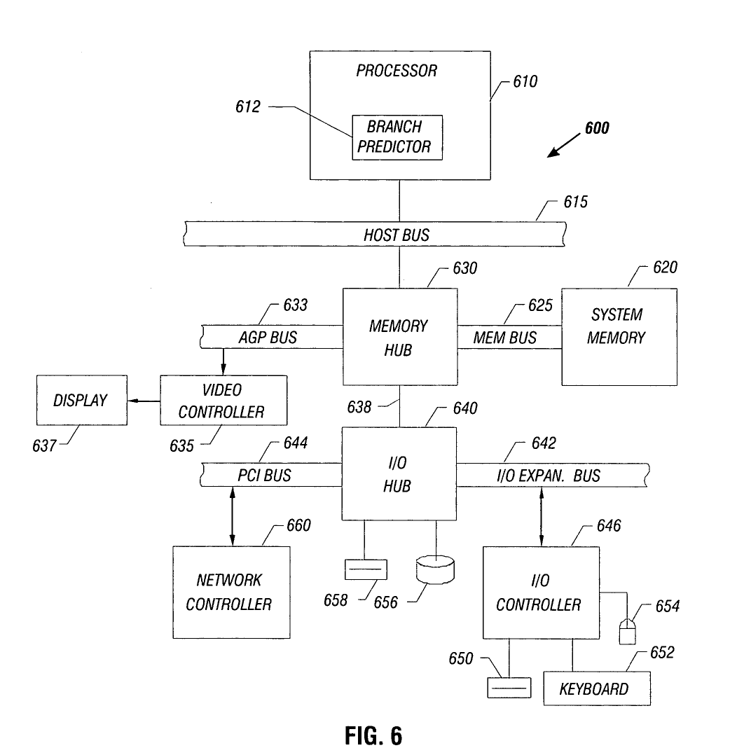

Referring now to FIG. 6, shown is a block diagram of computer system 600 with which embodiments of the invention may be used. In one embodiment, computer system 600 includes a processor 610, which may include a general-purpose or special-purpose processor such as a microprocessor, microcontroller, a programmable gate array (PGA), and the like. As used herein, the term “computer system” may refer to any type of processor-based system, such as a desktop computer, a server computer, a laptop computer, or the like, or other type of host system.

The processor 610 may include a branch predictor 612 which may be implemented according to any embodiment of the hybrid prophet/critic predictor of the present invention.

The processor 610 may be coupled over a host bus 615 to a memory hub 630 in one embodiment, which may be coupled to a system memory 620 (e.g., a dynamic RAM) via a memory bus 625. The memory hub 630 may also be coupled over an Advanced Graphics Port (AGP) bus 633 to a video controller 635, which may be coupled to a display 637. The AGP bus 633 may conform to the Accelerated Graphics Port Interface Specification, Revision 2.0, published May 4, 1998, by Intel Corporation, Santa Clara, Calif.

The memory hub 630 may also be coupled (via a hub link 638) to an input/output (I/O) hub 640 that is coupled to a input/output (I/O) expansion bus 642 and a Peripheral Component Interconnect (PCI) bus 644, as defined by the PCI Local Bus Specification, Production Version, Revision 2.1 dated June 1995. The I/O expansion bus 642 may be coupled to an I/O controller 646 that controls access to one or more I/O devices. As shown in FIG. 6, these devices may in one embodiment include storage devices, such as a floppy disk drive 650 and input devices, such as keyboard 652 and mouse 654. The I/O hub 640 may also be coupled to, for example, a hard disk drive 656 and a compact disc (CD) drive 658, as shown in FIG. 6. It is to be understood that other storage media may also be included in the system.

The PCI bus 644 may also be coupled to various components including, for example, a network controller 660 that is coupled to a network port (not shown). Additional devices may be coupled to the I/O expansion bus 642 and the PCI bus 644, such as an input/output control circuit coupled to a parallel port, serial port, a non-volatile memory, and the like.

Thus, a method, apparatus, system, and article for a hybrid prophet/critic predictor have been described. While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus comprising a second branch predictor to receive a first branch prediction for a branch under prediction (BUP) and to generate a second branch prediction for the BUP based on a branch future of the BUP.

2. The apparatus of claim 1, wherein the branch future of the BUP includes the first branch prediction and branch predictions for one or more branches subsequent to the BUP.

3. The apparatus of claim 2, wherein the second branch prediction is based on the branch future of the BUP and a branch history of the BUP.

4. The apparatus of claim 3, wherein the branch history of the BUTP is adapted to include branch predictions for one or more branches prior to the BUP.

5. The apparatus of claim 4, further comprising a first branch predictor to generate the first branch prediction and the branch predictions for the one or more subsequent branches to the BUP and the one or more branches prior to the BUP.

6. The apparatus of claim 5, wherein the first branch predictor is adapted to predict branches based on a program counter and/or a history of the first branch predictor's prior branch predictions.

7. The apparatus of claim 5, wherein the first branch predictor is a prophet and the second branch predictor is a critic.

8. An apparatus comprising:
a first branch predictor to generate a first branch prediction for a branch under prediction (BUP); and
a second branch predictor to generate a second branch prediction for the BUP based on a branch future of the BUP.

9. The apparatus of claim 8, wherein the first branch predictor is adapted to generate the first branch prediction based on a branch history of the BUP.

10. The apparatus of claim 8, wherein the first branch predictor is adapted to generate the first branch prediction based on a program counter.

11. The apparatus of claim 8, wherein the first branch predictor is adapted to generate the first branch prediction based on a branch history of the BUP and/or a program counter.

12. The apparatus of claim 9, wherein the first branch predictor is adapted to predict one or more branches prior to the BUP and the branch history of the BUP includes one or more of the prior branch predictions.

13. The apparatus of claim 8, wherein the first branch predictor is adapted to predict one or more branches subsequent to the BUP and the branch future of the BUP includes the first branch prediction and one or more of the subsequent branch predictions.

14. The apparatus of claim 8, further comprising a final unit to generate a final branch prediction based on the first and second branch predictions.

15. The apparatus of claim 14, wherein the final branch prediction is adapted to be determined by the second branch prediction.

16. The apparatus of claim 8, further comprising a filter unit to cause the second branch predictor to generate the second branch prediction when one or more conditions are met.

17. The apparatus of claim 16, wherein the conditions include a previous incorrect prediction of the BUP by the first branch predictor.

18. The apparatus of claim 8, wherein the second branch prediction is based on a branch history of the BUP and the branch future of the BUP.

19. The apparatus of claim 8, wherein the first branch predictor is a prophet and the second branch predictor is a critic.

20. A method comprising:
generating a first branch prediction for a branch under prediction (BUP); and
generating a second branch prediction for the BUP based on a branch future of the BUP.

21. The method of claim 20, wherein the first branch prediction is based on a branch history of the BUP.

22. The method of claim 20, wherein the first branch prediction is based on a branch history of the BUP and/or a program counter.

23. The method of claim 21, further comprising generating branch predictions for one or more branches prior to the BUP, wherein the branch history of the BUP includes one or more of the prior branch predictions.

24. The method of claim 20, further comprising generating branch predictions for one or more branches subsequent to the BUP, wherein the branch future of the BUP includes the first branch prediction and one or more of the subsequent branch predictions.

25. The method of claim 20, wherein the second branch prediction is generated when one or more conditions are met.

26. The method of claim 25, wherein the conditions include a previous incorrect branch prediction of the BUP.

27. The method of claim 20, wherein the second branch prediction is based on the branch history of the BUP and the branch future of the BUP.

28. A system comprising:
a dynamic random access system memory coupled to store instructions for execution by a processor; and
a branch prediction unit to provide a final branch prediction for a branch under prediction (BUP), wherein the branch prediction unit includes a first branch predictor to generate a first branch prediction for the BUP based on a program counter and/or a branch history of the BUP, and also includes a second branch predictor to generate a second branch prediction for the BUP based on a branch future of the BUP.

29. The system of claim 28, wherein the first branch predictor is adapted to predict one or more branches prior to the BUP and the branch history of the BUP is adapted to include one or more of the prior branch predictions.

30. The system of claim 28, wherein the first branch predictor is adapted to predict one or more branches subsequent to the BUP and the branch future of the BUP is adapted to include the first branch prediction and one or more of the subsequent branch predictions.

31. The system of claim 28, wherein the branch prediction unit includes a filter unit to cause the second branch predictor to generate the second branch prediction when one or more conditions are met.

32. The system of claim 31, wherein the conditions include a previous incorrect prediction of the BUP by the first branch predictor.

33. The system of claim 28, wherein the second branch prediction is based on the branch history of the BUP and the branch future of the BUP.

34. The apparatus of claim 28, wherein the first branch predictor is a prophet and the second branch predictor is a critic.

35. An article comprising a machine-accessible medium containing instructions that if executed enable a system to:
generate a first branch prediction for a branch under prediction (BUP) based on a program counter and/or a branch history of the BUP; and
generate a second branch prediction for the BUP based on a branch future of the BUP.

36. The article of claim 35, further comprising instructions that if executed enable the system to generate the second branch prediction based on the branch history of the BUP and the branch future of the BUP.

37. The article of claim 35, further comprising instructions that if executed enable the system to generate a final branch prediction based on the first and second branch predictions.

38. The article of claim 35, further comprising instructions that if executed enable the system to generate a final branch prediction determined by the second branch prediction.

39. The article of claim 35, further comprising instructions that if executed enable the system to generate the second branch prediction when a prior branch prediction for the BUP was incorrect.
